(19) United States
(12) Patent Application Publication
(10) Pub. No.: US 2019/0027091 A9
(43) Pub. Date: Jan. 24, 2019

(54) PIXEL CIRCUIT AND METHOD FOR DRIVING PIXEL CIRCUIT

(71) Applicant: SHENZHEN ROYOLE TECHNOLOGIES CO., LTD., Shenzhen (CN)

(72) Inventor: Ze Yuan, Shenzhen (CN)

(73) Assignee: SHENZHEN ROYOLE TECHNOLOGIES CO., LTD., Shenzhen (CN)

(21) Appl. No.: 15/738,714

(22) PCT Filed: Jul. 21, 2015
(86) PCT No.: PCT/CN2015/084713

§ 371 Date: Dec. 21, 2017

(51) Int. Cl. G09G 3/3233; G09G 3/3258

(52) U.S. Cl. CPC G09G 3/3233; G09G 2300/08; G09G 3/3258

(57) ABSTRACT

Disclosed are a pixel circuit and a method for driving the pixel circuit. The pixel circuit includes a driving transistor, a first transistor, a second transistor, a third transistor, a driving capacitor and a light-emitting element.

### FIELD

The present disclosure relates to a field of an organic light emitting display panel, and more particularly, to a pixel circuit capable of compensating a threshold voltage of an organic light emitting display panel and a method for driving the pixel circuit.

### BACKGROUND

As a current mode light-emitting device, an organic light-emitting diode (OLED for short) has been increasingly applied in high-performance organic light-emitting display panels. Referring to FIG. 1, the OLED display panel pixel circuit in the related art includes a driving transistor MD, a transistor M1 functioning as a switch, a capacitor C_{ST} and an organic light-emitting device, i.e., 2T1C. The organic light-emitting device includes an organic light-emitting diode D_{OLED} and an inductance capacitor C_{OLED} of the organic light-emitting diode D_{OLED}. The transistor M1 is connected to a data signal V_{DATA} and is controlled by a scanning signal V_{SCAN}. The driving transistor MD is connected to a pixel power supply V_{DD} and is also connected to the data signal V_{DATA} via the transistor M1. Two terminals of the capacitor C_{ST} are connected respectively to the pixel power supply V_{DD} and a node A between the transistor M1 and the driving transistor MD. The organic light-emitting diode D_{OLED} and the inductance capacitor C_{OLED} are connected in parallel between the transistor MD and an external power supply V_{SS}. The voltage of the external power supply V_{SS} is lower than the voltage of the pixel power supply V_{DD}, for example, the voltage of the external power supply V_{SS} can be the ground voltage. When a gate of the transistor M1 responds to scanning signal V_{SCAN} and conducts the transistor ML the capacitor C_{ST} is charged based on the data signal V_{DATA}, and then the voltage in the capacitor C_{ST} is applied on the gate of the driving transistor MD, thereby conducting the driving transistor MD, so that the organic light-emitting device through which current flows emits light.

The current provided to the organic light-emitting device via the driving transistor MD can be calculated by following formula:

I_{OLED}=½*β(V_{GS}−V_{TH})² formula 1

I_{OLED} is the current flowing through the organic light-emitting device. V_{GS} is a voltage applied between the gate and the source of the driving transistor MD, and V_{GS} is determined by a voltage across the C_{ST}. V_{TH} is a threshold voltage of the driving transistor MD. β is a gain factor of the driving transistor MD, which is determined by a size of the device and a carrier mobility of a semi-conductor. It can be seen from formula, the current flowing through the organic light-emitting device may be affected by the threshold voltage of the driving transistor MD. Since the threshold voltage of each transistor in the organic light-emitting display panel may be different from each other in a production process, as well as an electron mobility of each transistor. On this basis, the current I_{OLED} generated in the circuit is variable even given the same V_{GS}, thereby resulting non-uniformity of brightness.

### SUMMARY

Accordingly, the present disclosure aims to provide a pixel circuit that can eliminate the influence of a current variation caused by non-uniformity or drift of a threshold voltage on display effect and a method for driving the pixel circuit, and a display panel.

Embodiments of the present disclosure provide a pixel circuit, including: a driving transistor; a first transistor, a control electrode of the first transistor being connected to a first scanning line, and two controlled electrodes of the first transistor being connected to a data line and a control electrode of the driving transistor respectively; a second transistor, a control electrode of the second transistor being connected to a control line, and two controlled electrodes of the second transistor being connected to a first power line and a first controlled electrode of the driving transistor respectively; a third transistor, a control electrode of the third transistor being connected to a second scanning line, and two controlled electrodes of the third transistor being connected to a second power line and a second controlled electrode of the driving transistor respectively; a driving capacitor, two terminals of the driving capacitor being connected to the control electrode and the second controlled electrode of the driving transistor respectively; and a light-emitting element, comprising a light-emitting diode and an inductance capacitor of the light-emitting diode connected in parallel between a third power line and the second controlled electrode of the driving transistor.

Embodiments of the present disclosure provide a method for driving a pixel circuit, applied in the pixel circuit as described above, the driving transistor has a threshold voltage, including: conducting the first transistor, the second transistor and the third transistor, and charges stored in the driving capacitor being released to the data line and the second power line via the first transistor and the third transistor, respectively; conducting the first transistor and the second transistor, cutting off the third transistor, outputting by the data line a reference voltage to the driving transistor via the first transistor, a first voltage provided by the first power line being applied for charging the driving capacitor via the second transistor and the driving transistor until a voltage across a control electrode and a controlled electrode of the driving transistor being the threshold voltage; conducting the first transistor, cutting off the second transistor and the third transistor, outputting by the data line a data voltage higher than the reference voltage, and a voltage across the driving capacitor being charged to a sum of the threshold voltage and another voltage, the another voltage being related to a voltage difference between the data voltage and the reference voltage; and cutting off the first transistor and the third transistor, conducting the second transistor, driving by the driving capacitor the driving transistor to be conducted, such that the first voltage drives the light-emitting element to emit light.

Embodiments of the present disclosure provide a method for driving a pixel circuit, applied in the pixel circuit as described above, the driving transistor has a threshold voltage, including: conducting the first transistor, the second transistor and the third transistor, such that the driving transistor is conducted and a voltage across the driving capacitor and a voltage across the light-emitting element is reset; conducting the first transistor and the second transistor, cutting off the third transistor, enabling the data line to output a reference voltage, such that a voltage of a first node connecting the driving capacitor, the driving transistor and the light emitting element with each other is a voltage difference between the reference voltage and the threshold voltage; conducting the first transistor and the second transistor, cutting off the third transistor, enabling the data line to output a data voltage higher than the reference voltage, such that a voltage across the driving capacitor is a sum of the threshold voltage and another voltage, the another voltage being related to a voltage difference between the data voltage and the reference voltage; and cutting off the first transistor and the third transistor, conducting the second transistor, such that the driving transistor is driven by the driving capacitor to be conducted so as to drive the light-emitting element by a first voltage provided by the first power line to emit light.

### BRIEF DESCRIPTION OF THE DRAWINGS

The following drawings are intended to illustrate embodiments of the present disclosure in detail with reference to specific embodiments. It should be understood that, elements illustrated in drawings are not representative of actual size and ratio relationships and are merely illustrative, and should not to be construed as a limitation of the present disclosure.

FIG. 1 is schematic diagram of a pixel circuit in the related art.

FIG. 2 is a schematic diagram of a display panel according to an embodiment of the present disclosure.

FIG. 3 is a schematic diagram of a pixel circuit of a display panel in FIG. 2 according to an embodiment of the present disclosure.

FIG. 4a is a timing diagram according to an embodiment of the present disclosure and FIG. 4b is a schematic diagram of a pixel circuit in FIG. 3 at a first phase of the timing diagram.

FIG. 5a is a timing diagram and FIG. 5b is a schematic diagram of a pixel circuit in FIG. 3 at a second phase of the timing diagram.

FIG. 6a is a timing diagram and FIG. 6b is a schematic diagram of a pixel circuit in FIG. 3 at a third phase of the timing diagram.

FIG. 7a is a timing diagram and FIG. 7b is a schematic diagram of a pixel circuit in FIG. 3 at a fourth phase of the timing diagram.

FIG. 8 is a schematic diagram illustrating a relationship between a threshold voltage of a driving transistor of a pixel circuit in FIG. 3 and a change of a current flowing through a light-emitting diode.

FIG. 9 is a schematic diagram of a pixel circuit of a display panel in FIG. 2 according to another embodiment of the present disclosure.

FIG. 10a is a timing diagram of the pixel circuit in FIG. 3 according to another embodiment of the present disclosure and FIG. 10b is a schematic diagram of the pixel circuit in FIG. 3 at a third phase of the timing diagram.

FIG. 11 is a schematic diagram illustrating a relationship between a carrier mobility of a driving transistor of a pixel circuit and a current change of a light-emitting diode at the timing diagram of FIG. 10b.

### DETAILED DESCRIPTION

In order to make purposes, technical solutions and advantages of embodiments of the present disclosure more clear, reference will be made in detail to embodiments of the present disclosure with accompanying drawings. It should be understood that, the embodiments described herein according to drawings are explanatory and illustrative, and are not construed to limit the present disclosure.

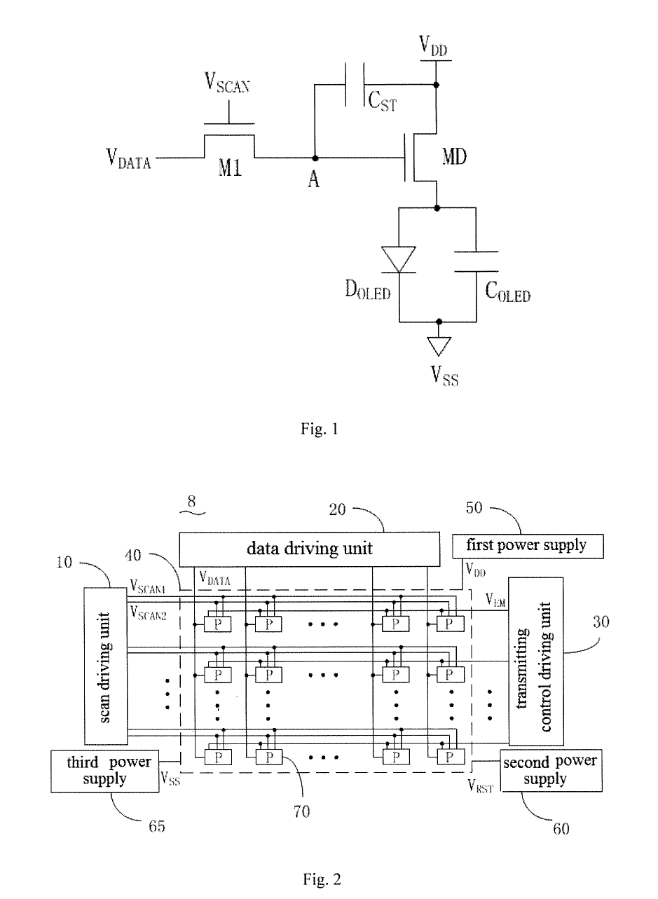

Referring to FIG. 2, a display panel 8 includes a scan driving unit 10, a data driving unit 20, an emitting control driving unit 30, a display unit 40, a first power supply 50, a second power supply 60 and a third power supply 65. The display unit 40 includes a plurality of pixel circuits 70 arranged in a matrix. The scan driving unit 10, the data driving unit 20 and the emitting control driving unit 30 are configured to provide a scanning signal V_{SCAN} (including a first scanning signal V_{SCAN1} and a second scanning signal V_{SCAN2}), a data signal V_{DATA} and a transmitting control signal V_{EM} to each pixel circuit 70, respectively. The first power supply 50, the second power supply 60 and the third power supply 65 are configured to provide a first voltage V_{DD}, a second voltage V_{RST} and the third voltage V_{SS} to each pixel circuit 70, respectively.

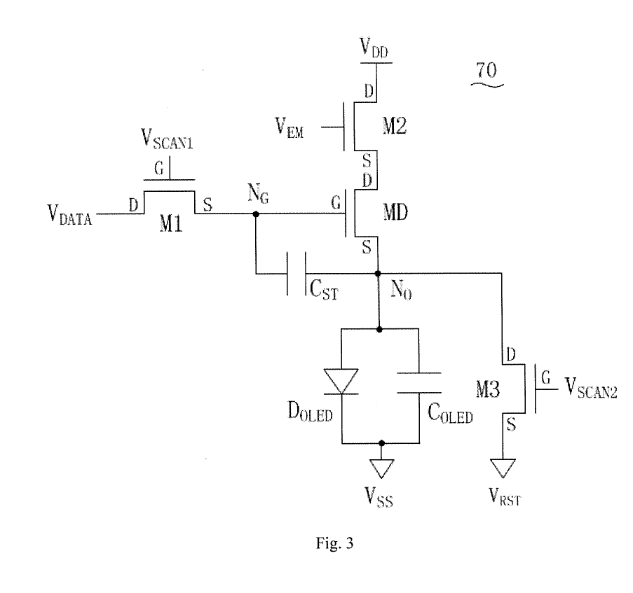

Referring to FIG. 3, in an embodiment of the present disclosure, the pixel 70 has a first scanning line configured to transmit a first scanning signal V_{SCAN1}, a second scanning line configured to transmit a second scanning signal V_{SCAN2}, a first power line configured to transmit a first power supply 50, a second power line configured to transmit a second power supply 60, a third power line configured to transmit a third power supply 65, a data line configured to transmit a data signal V_{DATA}, and a control line configured to transmit a transmitting control scanning signal V_{EM}.

The pixel circuit 70 further includes: a driving transistor MD; a first transistor M1, a control electrode of the first transistor M1 being connected to a first scanning line, and two controlled electrodes of the first transistor M1 being connected to a data line and a control electrode of the driving transistor MD respectively; a second transistor M2, a control electrode of the second transistor M2 being connected to a control line, and two controlled electrodes of the second transistor M2 being connected to a first power line and a first controlled electrode of the driving transistor MD respectively; a third transistor M3, a control electrode of the third transistor M3 being connected to a second scanning line, and two controlled electrodes of the third transistor M3 being connected to a second power line and a second controlled electrode of the driving transistor MD respectively; a driving capacitor C_{ST}, two terminals of the driving capacitor C_{ST} being connected to the control electrode and the second controlled electrode of the driving transistor MD respectively; and a light-emitting element, including a light-emitting diode D_{OLED} and an inductance capacitor C_{OLED} of the light-emitting diode connected in parallel between a third power line and the second controlled electrode of the driving transistor MD.

In detail, in following embodiments, an organic light-emitting diode (OLED for short) is an example of the light-emitting element. However, it should be understood that, the present disclosure is not limited to such example, the light-emitting element may also be an inorganic light-emitting diode. In following embodiments, the driving transistor MD, the first transistor M1, the second transistor M2 and the third transistor M3 are preferably thin-film field-effect transistors, and are specifically N-type thin-film field-effect transistors, but are not limited thereto, which may also be P-type thin-film field-effect transistors or other electronic devices capable of realizing switching functions, such as a triode. Those skilled in the art may know how transistors of other types operate according to descriptions of following embodiments, which will not be described in the present disclosure. In this case, a voltage value of the second voltage V_{RST} is lower than a voltage value of the first voltage V_{DD}, and the third voltage V_{SS} may be a ground voltage.

The driving transistor MD includes a control electrode and two controlled electrodes controlled to be conducted or non-conducted by the control electrode, in which, the control electrode is a gate G of the driving transistor MD, and the two controlled electrodes are a drain D and a source S. Similarly, the first transistor M1, the second transistor M2 and the third transistor M3 are in the same way as the driving transistor MD. A drain D and a source S of the first transistor M1 are connected to the data line and the gate G of the driving transistor MD respectively, and a gate G of the first transistor M1 is connected to the first scanning line. A drain D and a source S of the second transistor M2 are connected to the first power line and the drain D of the driving transistor MD respectively, and a gate G of the second transistor M2 is connected to the control line. A drain D and a source S of the third transistor M3 are connected to the source S of the driving transistor MD and the second power line respectively, and a gate G of the third transistor M3 is connected to the second scanning line. Two terminals of the driving capacitor C_{ST} are connected to the gate G and the source S of the driving transistor MD respectively. The light-emitting diode D_{OLED} of the light-emitting element and the inductance capacitor C_{OLED} of the light-emitting diode D_{OLED} are connected in parallel between the source S of the driving transistor MD and the third power line, and a cathode of the light-emitting diode D_{OLED} is connected to the third power line. In this embodiment, a node that connecting the first transistor M1, the driving capacitor C_{ST} and the driving transistor MD is defined as N_{G}, and a node that connecting the driving capacitor C_{ST}, the driving transistor MD, the light-emitting element and the third transistor M3 is defined as Nₒ.

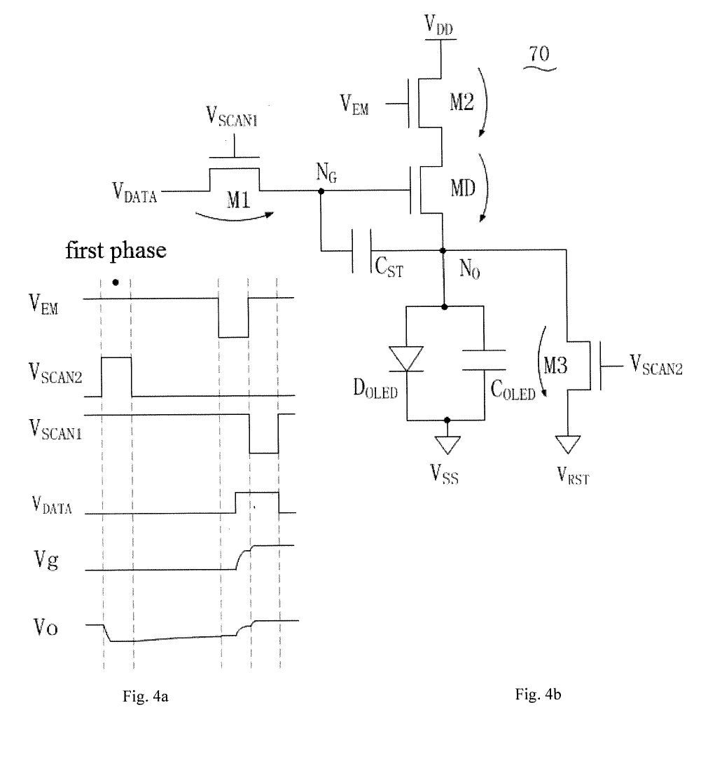

Referring to FIG. 4a and FIG. 4b, the pixel circuit 70 in FIG. 3 is configured to be operating according to a timing diagram of an embodiment illustrated in FIG. 4a. In the timing diagram illustrated in FIG. 4a, each operating cycle of the pixel circuit 70 can be divided into four phases. At a first phase, an operating condition of the pixel circuit 70 is illustrated in FIG. 4b. At the first phase, the driving capacitor C_{ST} and the inductance capacitor C_{OLED} are reset. In detail, the transmitting control signal V_{EM}, the first scanning signal V_{SCAN1} and the second scanning signal V_{SCAN2} are high-level signals. In this case, the first transistor M1, the second transistor M2 and the third transistor M3 are conducted, both terminals of the driving capacitor C_{ST}, that is, the node N_{G} and the node N_{O} are charged to a reference voltage V_{REF} written by the data line and the second voltage V_{RST} via the first transistor M1 and the third transistor M3 respectively, and a voltage difference between the reference voltage V_{REF} and the second voltage V_{RST} is higher than a threshold voltage V_{TH} of the driving transistor MD, i.e., V_{REF}−V_{RST}>V_{TH}, and at the same time, a voltage difference between the second voltage V_{RST} and the third voltage V_{SS} is lower than a threshold voltage of the light-emitting diode D_{OLED}. In this case, the driving transistor MD is conducted and the light-emitting element does not emit light, the driving capacitor C_{ST} is reset to be a preset voltage V_{REF}−V_{REF2}, and the inductance capacitor C_{OLED} is reset to a preset second voltage V_{REF2}−Vss. V_{REF2} is a voltage of the node N_{O} at this phase. Since a bias voltage setting of the V_{SCAN2}, a driving voltage of the M3 is large, a drain-source voltage is small, and the voltage V_{REF2} of the node N_{O} is close to V_{RST}.

In this embodiment, it is suitable for transistors with different threshold voltages that the second voltage V_{RST} and the third voltage V_{SS} are set to be different, thereby improving a flexibility of pre-charging each capacitor/each node at the first phase. However, it should be understood that, potentials of the second voltage V_{RST} and the third voltage V_{SS} may be the same as long as the voltage difference satisfies the above condition. That is, the third power supply 65 may be omitted, the light-emitting diode D_{OLED} and the inductance capacitor C_{OLED} can thus connected to the second power line directly, and in this case, the ground voltage may be output by the second power supply 60. Therefore, in descriptions and claims of the present disclosure, the voltage provided by the third power supply 65 may be consistent with the voltage provided by the second power supply 60. Furthermore, in other words, the third power supply 65 and the second power supply 60 may be a same power supply, that is, the second power line and the third power line may be a same power line, and a separate description thereof should not be construed as separate two power supplies to limit protection ranges of the present disclosure.

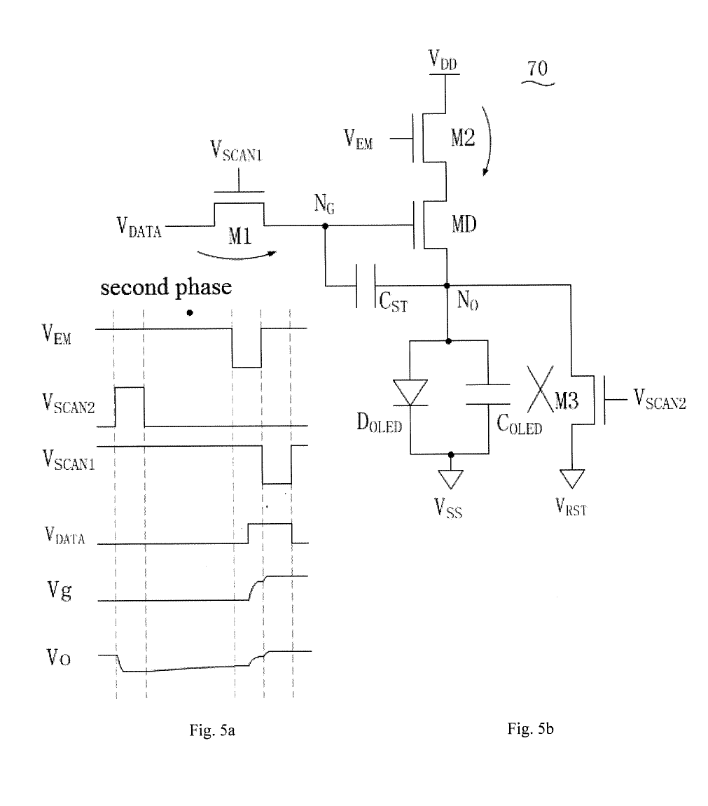

Referring to FIG. 5a and FIG. 5b, at the second phase, an operating condition of the pixel circuit 70 is illustrated in FIG. 5b. At the second phase, the node N_{O}, i.e., a terminal that connecting the driving capacitor C_{ST} and the source S of the driving transistor MD is charged to a voltage difference between the reference voltage V_{REF} and the threshold voltage V_{TH} of the driving transistor MD. In detail, the transmitting control signal V_{EM}, the first scanning signal V_{SCAN1} and the second scanning signal V_{SCAN2} are a high-level signal, a high-level signal and a low-level signal respectively. In this case, the first transistor M1 is conducted, the second transistor M2 is conducted and the third transistor M3 is cut off. In this case, the driving transistor MD is still conducted, the data line still is written with the reference voltage V_{REF}, and a voltage Vg of the node N_{G} thus remains at the reference voltage V_{REF}. Since the driving transistor MD is conducted, the driving capacitor C_{ST} is gradually charged by the first voltage V_{DD} via the driving transistor MD, until the voltage Vo of the node N_{O} is charged to be a voltage difference V_{REF}−V_{TH} between the reference voltage V_{REF} and the threshold voltage V_{TH} of the driving transistor MD. In this case, a voltage difference V_{GS} between the gate G and the source S of the driving transistor MD is V_{TH}. When the voltage Vo of the node N_{O} is further increased, the driving transistor MD may be cut off, thus the voltage V_{O} of the node N_{O} remains at V_{REF}−V_{TH}. At this phase, the driving transistor MD is conducted first and cut off in a very final end, and the light-emitting element does not emit light.

Another embodiment of the present disclosure is provided herein, which is different from a case that the third transistor M3 is connected in a diode method, i.e., the drain and the gate of the third transistor is connected together, and the driving transistor MD may be compensated only when V_{TH} is positive. In this embodiment, the node N_{G} and the node N_{O} can be charged with different potentials, and the drain and the gate need not be connected together, and thus even if the threshold is negative, the driving transistor can still be compensated. Therefore, in a compensation process of second phase described above, there is no additional requirement for the value of the threshold voltage V_{TH} of the driving transistor MD, V_{TH} may be positive or negative.

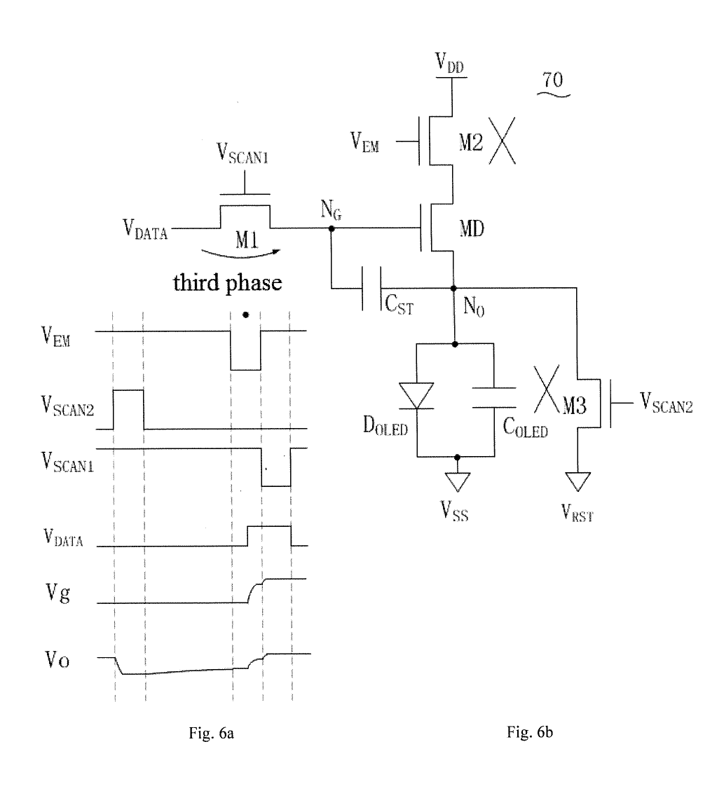

Referring to FIG. 6a and FIG. 6b, at a third phase, an operating condition of the pixel circuit 70 is illustrated in FIG. 6b. At the third phase, the second transistor M2 is cut off, thus a connection between the first power supply V_{DD} and the driving transistor MD is cut off, and a data voltage is input to the gate of the driving transistor MD. In detail, the transmitting control signal V_{EM}, the first scanning signal V_{SCAN1} and the second scanning signal V_{SCAN2} are a low-level signal, a high-level signal and a low-level signal respectively. In this case, the first transistor M1 is conducted, the second transistor M2 and the third transistor M3 are cut off, thus, there is no current flowing through the driving transistor MD. In this case, the data line outputs the data voltage V_{DATA} higher than the reference voltage V_{REF}, and the voltage of the node N_{G} is thus increased to V_{DATE}. A voltage change of the node N_{G} is shared by the driving capacitor C_{ST} and the inductance capacitor C_{OLED}. In this case, the voltage change value ΔV at the node N_{O} is:

(V_{DATA}−V_{REF})*[1/C_{OLED1}/(1/C_{ST1}+1/C_{OLED1})]−(V_{DATA}−V_{REF})*C_{ST1}/(C_{OLED1}+C_{ST1}).

C_{ST1} and C_{OLED1} are capacitance values of the driving capacitor C_{ST} and the inductance capacitor C_{OLED} respectively. In this case, the voltage of the node N_{O} is (V_{REF}−V_{TH})+ΔV. A voltage V_{ST} across the driving capacitor C_{ST} is:

$${V}_{DATA} - [ ( {V}_{REF} - {V}_{TH} ) + Δ V ] = {V}_{DATA} - [ ( {V}_{REF} - {V}_{TH} ) + ( {V}_{DATA} - {V}_{REF} ) * {C}_{ST 1} / ( {C}_{OLED 1} + {C}_{ST 1} ) ] = {V}_{TH} + ( {V}_{DATA} - {V}_{REF} ) * {C}_{OLED 1} / ( {C}_{OLED 1} + {C}_{ST 1} ) .$$

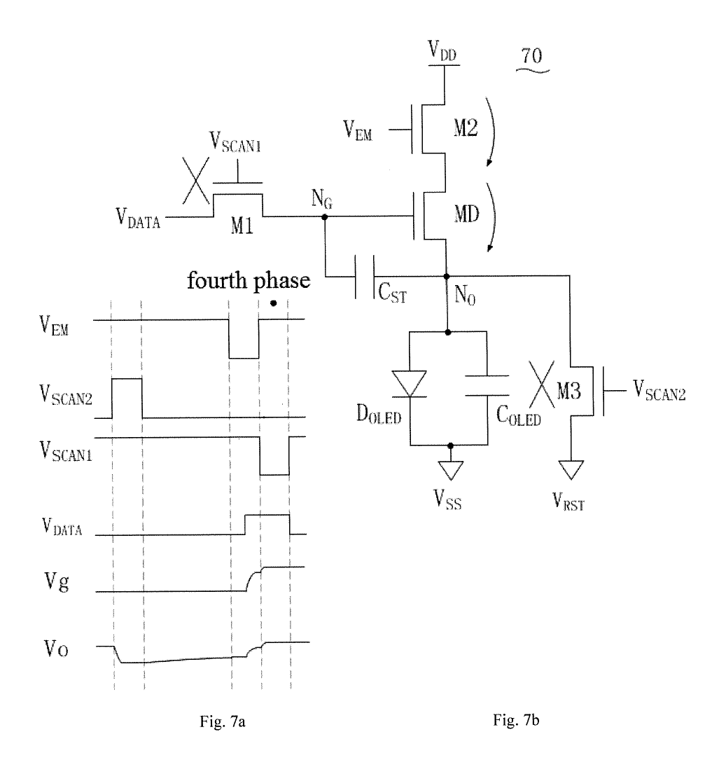

Referring to FIG. 7a and FIG. 7b, at a fourth phase, an operating condition of the pixel circuit 70 is illustrated in FIG. 7b. At the fourth phase, the transmitting control signal V_{EM}, the first scanning signal V_{SCAN1} and the second scanning signal V_{SCAN2} are a high-level signal, a low-level signal and a low-level signal respectively. In this case, the first transistor MI and the third transistor M3 are cut off, and the second transistor M2 is conducted, and with an effect of power stored in the driving capacitor C_{ST}, the V_{GS} is higher than V_{TH} and the driving transistor MD is thus conducted. In this case, current generated by the first power supply V_{DD} flows through the light-emitting diode D_{OLED} to enable the light-emitting diode D_{OLED} to emit light and also flows through the inductance capacitor C_{OLED}. At a beginning phase of the fourth phase, the potential of Vo is low, and the light-emitting diode D_{OLED} is cut off, therefore, most of the current flows through C_{OLED}, and the C_{OLED} is charged, so that the potential of N_{O} is increased. The voltage difference V_{GS} between the gate and the source of the driving transistor MD is determined by the voltage across the C_{ST}. Since the first transistor M1 is cut off at this phase, no current flows through M1, the voltage across the C_{ST} remains constant, and the potential of V_{G} of the node N_{G} is increased with the increase of the Vo. Finally, the Vo is increased to a certain potential and then remains constant, and all of the current flowing from the power supply V_{DD} flows through the light-emitting diode D_{OLED}. It can be seen from formula 1 in background, in this case, the current flowing through the light-emitting element may be:

$${I}_{OLED} = 1 / 2 * {β ( {V}_{TH} + ( {V}_{DATA} - {V}_{REF} ) * {C}_{OLED 1} / ( {C}_{OLED 1} + {C}_{ST 1} ) - {V}_{TH} )}^{2} = 1 / 2 * {β ( ( {V}_{DATA} - {V}_{REF} ) * {C}_{OLED 1} / ( {C}_{OLED 1} + {C}_{ST 1} ) )}^{2}$$

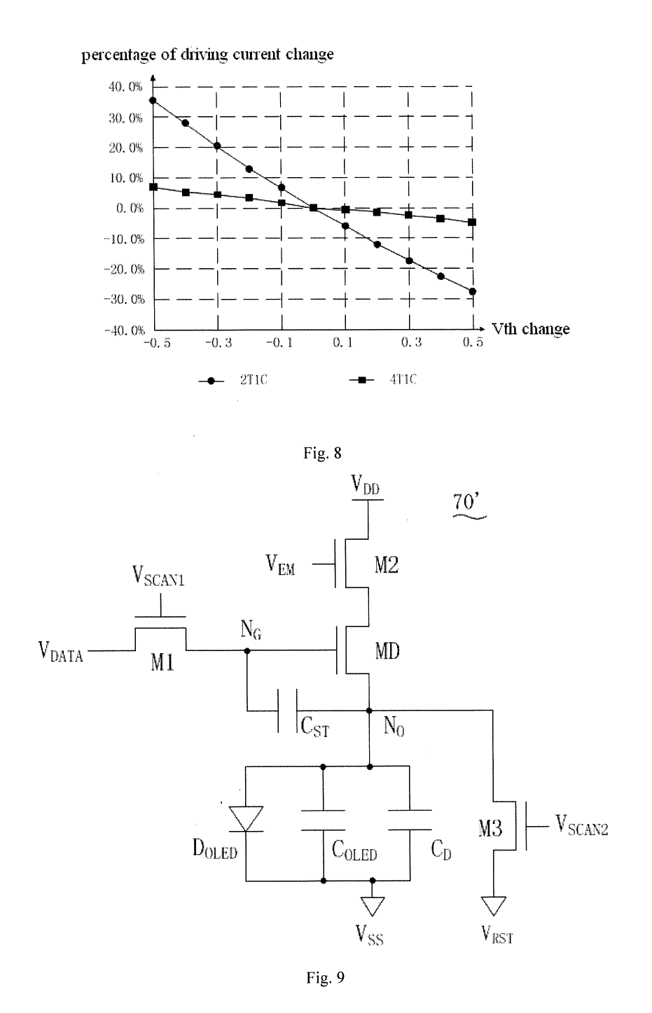

It can be seen from above formula, in the fourth phase, the current flowing through the light-emitting element is related only to voltages V_{REF} and V_{DATA} provided by the data line at different phases, the capacitance value C_{ST1} of the driving capacitor C_{ST} and the capacitance value C_{OLED1} of the inductance capacitor C_{OLED}, thereby reducing an influence of the change of the threshold voltage on the light-emitting element. As illustrated in FIG. 8, compared with the 2T1C structure in the related art, a current change of a 4T1C structure of the present disclosure is reduced significantly under a same change of the threshold voltage V_{TH}, thereby improving uniformity of brightness of the display panel 8.

Referring to FIG. 9, FIG. 9 is a schematic diagram of another pixel circuit 70′ of a display panel in FIG. 2 according to an embodiment of the present disclosure. The difference between the pixel circuit 70′ and the pixel circuit 70 of the above embodiment lies in that the pixel circuit 70′ further includes an additional capacitance C_{D} in parallel to the light emitting-element. The additional capacitance C_{D} is configured to increase a parallel capacitance value obtained by subjecting the additional capacitance C_{D} being connected in parallel to the inductance capacitor C_{OLED} when the capacitance value C_{OLED1} of the inductance capacitor C_{OLED} is small, such that the parallel capacitance value is far higher the capacitance value C_{ST1} of the driving capacitor C_{ST}, so that a voltage change of the node N_{O} can be calculated in the same way as calculating the voltage change of the node N_{O} described in the above embodiment. In this case, the voltage change of the node N_{O} is:

(V_{DATA}−V_{REF})*[1/C_{OLED1}′/(1/C_{ST1}+1/C_{OLED}′)]

C_{OLED1}′ is the parallel capacitance value of the inductance capacitor C_{OLED} and the additional capacitance C_{D} connected in parallel. A calculation principle and operating principle of the C_{OLED1} are similar to those described above, which is not described in detail here.

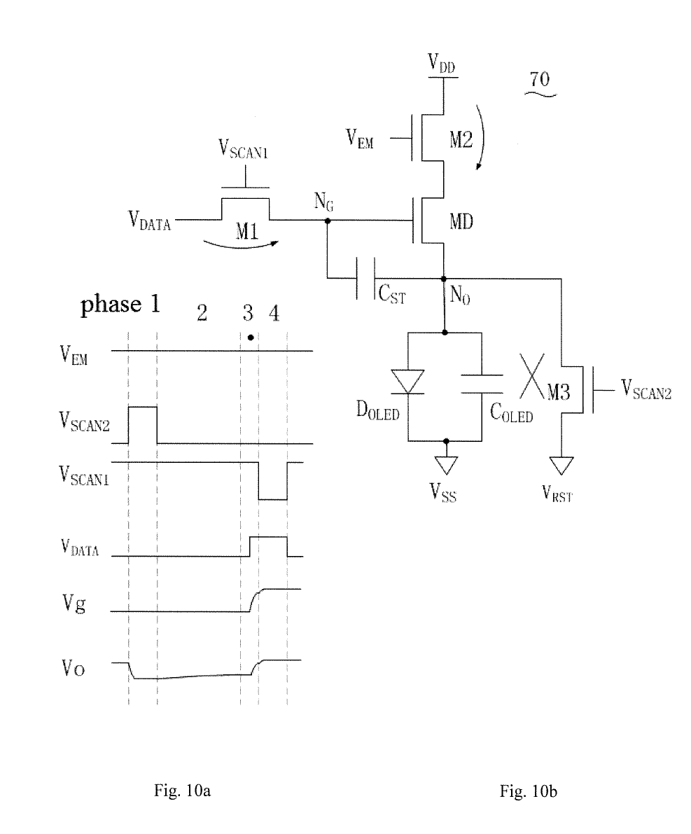

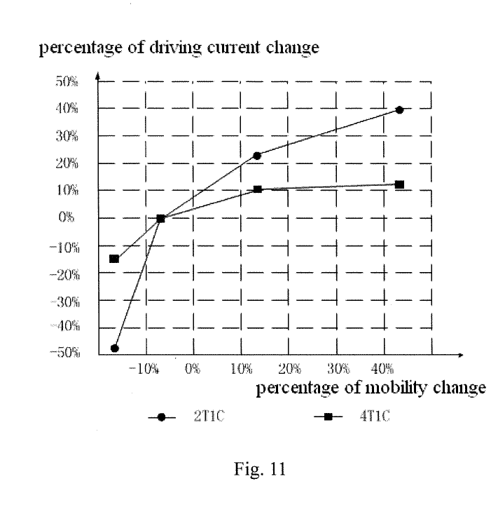

Referring to FIG. 10a, FIG. 10a is another timing diagram of the pixel circuit in FIG. 3 according to an embodiment of the present disclosure. The difference between the present embodiment and the embodiment described above lies in that the transmitting control signal V_{EM} remains at a high level at the first to the fourth phases, thereby allowing the pixel circuit 70 to perform a mobility compensation. In detail, in the timing diagram of the present embodiment, operations at the first and the second phase are the same as those of the above embodiment, which is not described here. At the third phase, an operation of the pixel circuit 70 is illustrated in FIG. 10b, the first transistor M1 and the second transistor M2 are conducted, and the third transistor is cut off. The node N_{O} is charged by the first power supply V_{DD} via the driving transistor MD, and a charging efficiency is determined by a mobility of the driving transistor MD. When the mobility of the driving transistor MD is high, the charging efficiency is high, the node N_{O} is charged to a higher voltage, and thus the voltage across the driving capacitor C_{ST} becomes small. When the mobility of the driving transistor MD is low, the node N_{O} is charged to a lower voltage, thereby achieving the mobility compensation. Certainly, a length of the third phase also determines a degree of the compensation. An effect of the above dynamic compensation effect can be seen in FIG. 11, compared with the 2T1C structure in the related art, the 4T1C structure can perform better compensation for a change of the mobility. It should be understood that, the pixel circuit 70′ described above is also applicable to a driving mode in this timing diagram.

In descriptions of the present disclosure, terms such as “first” and “second” are used herein for purposes of description and are not intended to indicate or imply relative importance or significance. Thus, the feature defined with “first” and “second” may comprise one or more this feature. In the description of the present disclosure, “a plurality of” means two or more than two, unless specified otherwise.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

The above descriptions are only preferred embodiment of the present disclosure, and cannot be construed to limit the present disclosure, and changes, alternatives, and modifications can be made in the embodiments without departing from spirit, principles and scope of the present disclosure.

1. A pixel circuit, comprising:
a driving transistor;
a first transistor, a control electrode of the first transistor being connected to a first scanning line, and two controlled electrodes of the first transistor being connected to a data line and a control electrode of the driving transistor respectively;
a second transistor, a control electrode of the second transistor being connected to a control line, and two controlled electrodes of the second transistor being connected to a first power line and a first controlled electrode of the driving transistor respectively;
a third transistor, a control electrode of the third transistor being connected to a second scanning line, and two controlled electrodes of the third transistor being connected to a second power line and a second controlled electrode of the driving transistor respectively;
a driving capacitor, two terminals of the driving capacitor being connected to the control electrode and the second controlled electrode of the driving transistor respectively; and
a light-emitting element, comprising a light-emitting diode and an inductance capacitor of the light-emitting diode connected in parallel between a third power line and the second controlled electrode of the driving transistor.

2. The pixel circuit according to claim 1, wherein the driving transistor, the first transistor, the second transistor, and the third transistor are thin-film field-effect transistors.

3. The pixel circuit according to claim 1, wherein a first voltage provided by the first power line is higher than a second voltage provided by the second power line.

4. The pixel circuit according to claim 3, wherein a voltage difference between the first voltage and the second voltage is higher than a threshold voltage of the driving transistor, and a voltage difference between the second voltage and a third voltage provided by the third power line is lower than a threshold voltage of the light-emitting diode.

5. The pixel circuit according to claim 4, wherein the third voltage is a ground voltage.

6. The pixel circuit according to claim 1, wherein comprising:
the driving transistor has a gate;
the first transistor is connected between the data line and the gate of the driving transistor and has a gate connected to a first scanning line;
the second transistor is connected between the first power line and the driving transistor and has a gate connected to the control line;
the third transistor is connected between the second power line and the driving transistor and has a gate connected to the second scanning line;
the light-emitting element is connected between the third power line and the driving transistor;
the driving capacitor is connected between the gate of the driving transistor and the light-emitting element; and
the pixel circuit further comprises an additional capacitor connected in parallel to the light-emitting element.

7. The pixel circuit according to claim 6, wherein a drain and a source of the driving transistor are connected to the second transistor and the light-emitting element respectively.

8. The pixel circuit according to claim 6, wherein a drain and a source of the first transistor are connected to the data line and the gate of the driving transistor respectively.

9. The pixel circuit according to claim 6, wherein a drain and a source of the second transistor are connected to the first power line and the driving transistor respectively.

10. The pixel circuit according to claim 6, wherein a drain and a source of the third transistor are connected to the driving transistor and the second power line respectively.

11. The pixel circuit according to claim 6, wherein the light-emitting element comprises a light-emitting diode, an anode of the light-emitting diode connected to the driving transistor, and a cathode of the light-emitting diode connected to the third power line.

12. The pixel circuit according to claim 11, wherein a voltage provided by the third power line is a ground voltage.

13. The pixel circuit according to claim 11, wherein a first voltage provided by the first power line is higher than a second voltage provided by the second power line.

14. The pixel circuit according to claim 13, wherein a voltage difference between the first voltage and the second voltage is higher than a threshold voltage of the driving transistor, and a voltage difference between the second voltage and a third voltage provided by the third power line is lower than a threshold voltage of the light-emitting diode.

15. (canceled)

16. A method for driving a pixel circuit, applied in a pixel circuit according to claim 1, and the driving transistor having a threshold voltage, the method comprising:
conducting the first transistor, the second transistor and the third transistor, and charges stored in the driving capacitor being released to the data line and the second power line via the first transistor and the third transistor, respectively;
conducting the first transistor and the second transistor, cutting off the third transistor, outputting by the data line a reference voltage to the driving transistor via the first transistor, a first voltage provided by the first power line being applied for charging the driving capacitor via the second transistor and the driving transistor until a voltage across a control electrode and a controlled electrode of the driving transistor being the threshold voltage;
conducting the first transistor, cutting off the second transistor and the third transistor, outputting by the data line a data voltage higher than the reference voltage, and a voltage across the driving capacitor being charged to a sum of the threshold voltage and another voltage, the another voltage being related to a voltage difference between the data voltage and the reference voltage; and
cutting off the first transistor and the third transistor, conducting the second transistor, driving by the driving capacitor the driving transistor to be conducted, such that the first voltage drives the light-emitting element to emit light.

17. The method according to claim 16, wherein, charges stored in the driving capacitor being released to the data line and the second power line via the first transistor and the third transistor respectively further comprises:
enabling the data line to provide the reference voltage, enabling the second power line to provide a second voltage, and a voltage difference between the first voltage and the second voltage being higher than the threshold voltage.

18. The method according to claim 17, wherein, charges stored in the driving capacitor being released to the data line and the second power line via the first transistor and the third transistor respectively further comprises:
enabling a voltage difference between the second voltage and a third voltage provided by the third power line to be lower than a threshold voltage of the light-emitting element.

19. A method for driving a pixel circuit, applied in a pixel circuit according to claim 1, the driving transistor having a threshold voltage, comprising:
conducting the first transistor, the second transistor and the third transistor, such that the driving transistor is conducted and a voltage across the driving capacitor and a voltage across the light-emitting element is reset;
conducting the first transistor and the second transistor, cutting off the third transistor, enabling the data line to output a reference voltage, such that a voltage of a first node connecting the driving capacitor, the driving transistor and the light emitting element with each other is a voltage difference between the reference voltage and the threshold voltage;
conducting the first transistor and the second transistor, cutting off the third transistor, enabling the data line to output a data voltage higher than the reference voltage, such that a voltage across the driving capacitor is a sum of the threshold voltage and another voltage, the another voltage being related to a voltage difference between the data voltage and the reference voltage; and
cutting off the first transistor and the third transistor, conducting the second transistor, such that the driving transistor is driven by the driving capacitor to be conducted so as to drive the light-emitting element by a first voltage provided by the first power line to emit light.

20. The method according to claim 19, wherein
enabling the data line to provide the reference voltage, enabling the second power line to provide a second voltage, a voltage difference between the first voltage and the second voltage being higher than the threshold voltage, and a voltage difference between the second voltage and a third voltage provided by the third power line being lower than a threshold voltage of the light-emitting element.
